(19) United States
(12) Patent Application Publication
(10) Pub. No.: US 2021/0225192 A1
(43) Pub. Date: Jul. 22, 2021

(54) PIANO TEACHING SYSTEM

(71) Applicant: Paul William WELLS, Milton Keynes (GB)

(72) Inventor: Paul William WELLS, Milton Keynes (GB)

(21) Appl. No.: 17/168,355

(22) Filed: Feb. 5, 2021

Related U.S. Application Data
(63) Continuation-in-part of application No. 29/721,425, filed on Jan. 21, 2020.

(30) Foreign Application Priority Data
Feb. 10, 2020 (GB) 2001752.1

(51) Int. Cl. G09B 15/02; G10H 1/00; G09B 15/08; G09B 15/04

(52) U.S. Cl. CPC G09B 15/023; G09B 15/04; G09B 15/08; G10H 1/0016

(57) ABSTRACT

A method, system and associate peripheral device for remotely teaching piano. The device (13/23) comprises a plurality of indicator LEDs along its length for arrangement/alignment across a student piano keyboard (11). When a key is triggered on a remote piano keyboard (21), e.g., by a teacher, one of the LEDs lights up at the equivalent key at the student piano keyboard. The system also allows for playing notes from the student or teacher piano keyboard, communicated over the internet, at the teacher or student piano keyboard and vice versa.

### CROSS REFERENCE TO RELATED APPLICATIONS

This application claims priority to GB Patent Application 2001752.1 filed on Feb. 10, 2020, and is a Continuation-In-Part of U.S. Design patent application 29/721,425 filed on Jan. 21, 2020, the entire disclosures of which are hereby incorporated by reference and relied upon.

### BACKGROUND OF THE INVENTION

Field of the Invention. The invention relates generally to a piano teaching system and peripheral device, particularly a method for use over a communication network, i.e. to facilitate teaching of piano via internet in order to save time and resources spent travelling.

Description of Related Art. It is common for the skills to play a piano to be taught by a teacher to a student in a one-on-one session, gathered around an acoustic piano or equivalent electronic keyboard. By this method the teacher has the opportunity to demonstrate skills and to observe the technique of the student, while suggesting corrections, with a view to improving the student's command of the instrument.

In recent times the Internet has made it possible for a music student to be located remotely from a teacher, e.g., by the use of video conferencing and like technologies. However, the use of cameras at different perspectives and sub-optimal sound quality render such solutions inferior to the traditional method of one-on-one tutorials at a common location.

### BRIEF SUMMARY OF THE INVENTION

The present invention seeks to provide a piano teaching system that mitigates at least some of the shortcomings of available internet-based teaching methods. In one broad aspect there is provided a peripheral device according to claim 1. A method and system for implementing the device are defined by claims 9 and 11.

In its most basic form, the piano teaching system incorporates a peripheral device featuring a strip of lights formed in an elongate body, placed across a student's piano keyboard and connected, via the internet or some other network, to a teacher's piano. The peripheral device may include a contoured/profiled surface to fit against the piano keyboard. In a preferred form at least part of the elongate body is of a flexible construction so it does not bounce around during playing and/or can be curled for ease of storage/transport. The elongate body of the device may be comprised of a plurality of modules, each of which represent an octave of a keyboard. In this way, a shorter or longer form of the device covers less or more of the piano keyboard as required.

The inventive concept involves provision for a teacher to press a key on their piano to remotely indicate, via a light on the student's keyboard, which key the student should press or otherwise be aware of. Additional functions include colour coding the lights (e.g. multiple light colours available for each piano key) to indicate finger position, e.g. red for thumb, green for forefinger, etc.

In one form the student piano may become a slave to the teacher piano, so a piece of music played by the teacher is replicated by the student's piano and vis-versa. The system may be accompanied by a video link (e.g. displayed on a common available screen such as a smart phone or tablet), however, having indicators directly on the keyboard avoids any confusion as to finger placement introduced by a disorienting camera perspective or like drawbacks of available internet-based systems.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 illustrates a schematic view of a piano teaching system according to the invention; and

FIG. 2 illustrates a peripheral device, i.e., a piano teaching aid, in a form suitable for use with the system of FIG. 1.

### DETAILED DESCRIPTION OF THE INVENTION

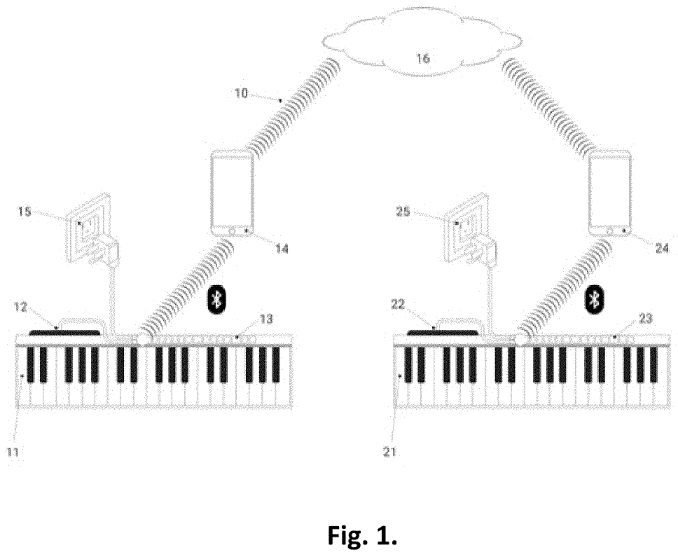

Referring to FIG. 1, the components of the system 10 of the invention include a first piano keyboard 11 at a first location, preferably equipped with USB connection 12 and on-board MIDI capability, associated with a first teaching aid device 13, a first processor 14 (e.g., a smartphone or tablet) and a first power socket 15. The first processor 14 preferably communicates wirelessly via a communication network, e.g., world wide web/internet 16, to a second processor 24. Analogous components, e.g., a second piano keyboard 21, preferably equipped with USB connection 22 and on-board MIDI capability, associated with a second teaching aid device 23; connect with the second processor at a second location, remote from the first. The first location may be a teacher location and the second location may be a student location or vice-versa.

In a preferred implementation of the invention, a software application (commonly known as an “app”) is installed on a user's smartphone, e.g. the first 14 and second 24 processors, which guides the user through the rest of the setup process. The app manages communication between respective piano keyboards 11/21, teaching aids 13 and between locations. The implementation may also include an exchange server that manages accounts, authentication, MQTT channels, updating firmware on the peripheral devices via the app, storing statistics, etc. Indeed, the invention may implemented with multiple students receiving tuition from a common teacher.

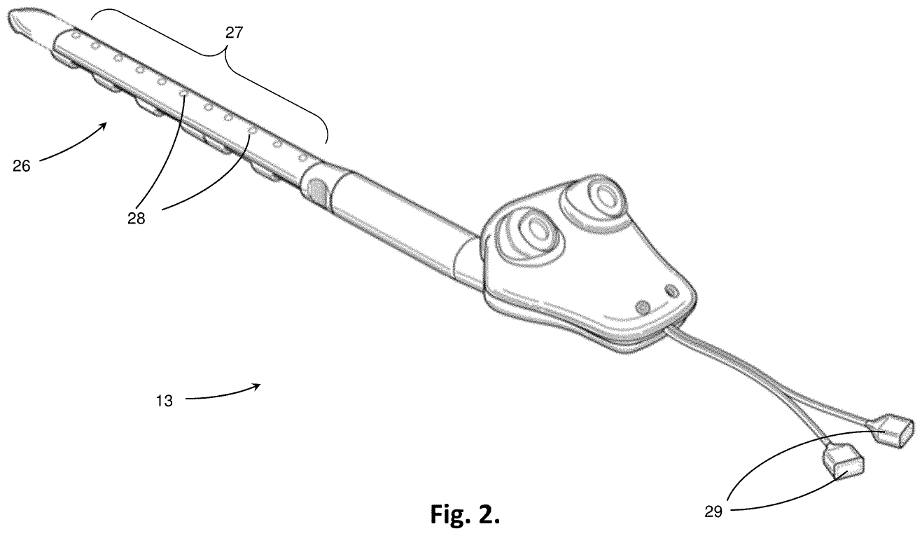

In a preferred form the peripheral device 13, shown in more detail in FIG. 2, is “snake-like” in shape. The peripheral device may include a contoured/profiled surface 26 to fit against the piano keyboard. In a preferred form at least part of the elongate body is of a flexible construction, so it does not bounce around during playing and/or can be curled for ease of storage/transport. The elongate body of the device may be comprised of a plurality of modules 27, each of which represent an octave of a keyboard. In this way, a shorter or longer form of the device covers less or more of the piano keyboard as required.

Preferably the app explains to the user how to position the snake on the piano keyboard, e.g. at the back of the keys so they can still be played. Each device 13 includes a series of indicators 28, such as LEDs, positioned in alignment with the piano keys. Power is connected from a mains adapter 15 to one of the USB ports 29 of the device 13, or may alternatively be battery powered or equivalent. Another USB port 29 on the device 13 is connected to the MIDI USB port 12 on the digital piano 11. Features of the device 13 may be mirrored by device 23.

The smartphone 14 is wirelessly paired (e.g., Bluetooth®) to the device 13 so that MIDI note events can be transmitted and received bidirectionally. In one form the app allows a test to be performed to confirm that notes can be played, recorded, stored remotely and played back with corresponding lights being lit on a remote device 23 so as to confirm connectivity.

Once the teacher and pupil both have their devices 13/23 set up then they may start an audio/video call using, for example, Skype® or WhatsApp® or a dedicated teaching application. The teacher may use the app to generate an authentication key which is shared via text with the pupil who pastes it into the app. This then authenticates and connects both app instances allowing them to send messages to each other via, by way of example, mqtt (Message Queue Telemetry Transport: a lightweight messaging protocol typically used for IOT—Internet of Things—applications).

The system and method of the invention is useful as a tool for teaching piano lessons. Particularly, during a piano lesson the teacher is able to listen to the pupil's playing as relayed through the teacher's piano (i.e., using the sound generating means at the local piano for a best quality experience, as opposed to sounds transmitted over the video call). Whenever the teacher wishes to give instruction to the pupil then the teacher can, at the same time as a verbal narrative through the audio/video call, point out the exact keys being discussed to the pupil by pressing those keys on the teacher's piano. Pressing keys on the teacher's piano causes corresponding lights to be lit on the pupil's teaching device 13, corresponding to a piano key and/or for notes to sound on the pupil's piano.

By selecting specific control features in the app the teacher can optionally only cause lights to be lit without notes being played, or notes to be played without lights being lit.

The system of the invention closely emulates how a co-located teacher would normally interact with a pupil, e.g., by pointing to keys on the keyboard (lights only) or by playing a phrase in demonstration (lights and sound). Additionally, a co-located teacher commonly asks the pupil to turn away from the keyboard while the teacher plays notes or combinations of notes which the pupil is asked to sing or otherwise identify (sound only). Aural tests like this form part of the curriculum for piano examinations.

The device 13/23 may include multiple or changeable indicators, e.g. coloured light options, such that by making further selections in the app the teacher can control the colour of any light which is lit for the pupil. For example, the teacher may give the instruction: “place your thumb where I am showing you in red, and your fifth finger where I am showing you in green”. In this way more detailed instructions can be given between teacher and student.

In a preferred form of the invention the “MIDI” protocol is utilised. The Musical Instrument Digital Interface (MIDI) standard was established between musical instrument makers in the 1980s. It standardises the protocol for key events such as down or up, key number and velocity. Modern digital piano keyboards emit and consume key events via USB. Via the USB connection the teaching aid device 13/23 is able to ‘hear’ and ‘play’ the connected piano, for subsequent transmission over the internet.

The device 13/23 preferably communicates bidirectionally with the app running on the smartphone via Bluetooth®. The device notifies the app of key events originating from the piano.

As mentioned, the Message Queue Telemetry Transport (MQTT) protocol can be used by IoT devices to communicate with each other bidirectionally. The app of the system preferably uses MQTT to communicate with other instances of itself (such as between the teacher's smartphone and the pupil's smartphone). Hence notes, or groups of notes, can be encoded and transmitted between smartphones as messages.

The invention effects mirroring of notes played follows a USB-Bluetooth-MQTT-Bluetooth-USB route.

One form of the invention involves multiple light emitting possibilities. Such can be achieved by a “NeoPixel” protocol, e.g. a component which contains light emitting diodes (LEDs). Neopixels can be chained together with rail, clock and data connections. Instructions to change the state of a light pass through the chain until they reach the enumerated pixel. For example, “set pixel 17 to green”. The device PCB can take instructions via Bluetooth® and generate the signal to cause the desired light colour and brightness change.

According to the invention, where notes played are shown as lights, then the path is (from the teacher's end first) USB-Bluetooth-MQTT-Bluetooth-Neopixel.

Variations of components are possible, that still fall within the scope of the general inventive concept. For example, the invention may be implemented by use of motion sensors at a teacher's key-based device, that detects a key strike to be transmitted as a signal to trigger a light at a student's key-based device. Such a solution achieves the basic function of enabling a teacher to direct a student's fingers to particular keys of a keyboard during a lesson.

In the illustrated form, and for manufacturing convenience, the first and second teaching aid devices 13/23 are the same, i.e., both equipped with indicators and bi-directional communications features, however, alternative forms of the system may only require the student device to include indicator lights. A teacher's device may have more basic features so long as it is capable of transmitting finger position information over the internet to assist teaching. The teacher's device could be a small unit that does not need to extend across piano keys, since aligned indicator lights are not essential.

It will be apparent from the foregoing that the invention sets out to solve a problem experienced by piano teachers giving piano lessons remotely, since piano pupils prefer to keep their eyes on their hands on the keyboard. In a conventional lesson a piano teacher sat next to a pupil can point at the keyboard to correct mistakes or to otherwise explain what to do on the keyboard. Giving a piano lesson via video call has the significant drawback that the pupil is required periodically to take their eyes off the keyboard and look at the video (phone/tablet) screen; transferring what they have just seen on a screen back on the keyboard is disorienting.

The present invention utilises, in one form, a device which resembles a snake. The pupil and teacher will lay the snake along the piano keyboard and plug it into the USB port on the piano. An app on a mobile device will control the snake, allowing a ‘session’ to be created connecting the two snakes across the Internet. Once in a session, playing notes on one piano will cause the same note to be played on the remote piano, and lights on the snake's body to indicate to the remote user which keys were pressed.

In a broad aspect the invention relates to a method, system and associate peripheral device for remotely teaching piano. The device comprises a plurality of indicator LEDs along its length for arrangement/alignment across a student piano keyboard. When a key is triggered on a remote piano keyboard, e.g., by a teacher, one of the LEDs lights up at the equivalent key at the student piano keyboard. The system allows for playing notes from the student or teacher piano keyboard, communicated over the internet, at the teacher or student piano keyboard and vice versa.

Indeed, there are numerous benefits associated with the invention; for example, observing indicator lights on the keys while listening to the voice of the teacher makes a remote piano lesson less tiring for the pupil. From the piano teacher's perspective, it is simpler to explain by effectively pointing to keys on the remote pupil's piano. The result is more obvious than having to provide a verbose narrative or ask the pupil to look away at the phone screen.

The sound quality of local and remote playing are made equal. The sound generator and amplifier in a digital piano makes no distinction between note events generated by the local keyboard and note events received through the USB port. The device relays note events received via Internet to and from the digital piano by USB. The balance in sound levels achieved allows the teacher to convey subtle differences in loudness which would be difficult to effectively convey over the audio channel of a video call. Legato and staccato (smooth and detached) phrases are also difficult to teach over an audio link without high quality audio equipment at both ends.

Teaching by duet can be a powerful way to engage a pupil with a piece of music. Here, for example, the teacher plays the right-hand part while the pupil plays the left-hand part. This can only be achieved with balanced sound levels as described above.

While transmitting note events over a network some variation in the delivery speed of those events may occur. Preferably the app/system includes an option to allow the application of smoothing to the stream of notes. This can be achieved by timestamping each event in the transmitting instance of the app, while the instance of the app at the receiving end uses the timestamp information to compensate for event delivery time variations. In this embodiment there is a trade-off between delay (the average time to deliver events) and jitter (the variation in delivery times of events).

For listening to a performance (mostly from pupil to teacher and occasionally from teacher to pupil) minimisation of jitter is the priority. Conversely, when giving verbal instructions with the indicator lights as visual cues as described, then immediacy of delivery of the event is the priority.

There is the possibility for more collaboration while learning music. Instead of the teacher to pupil mode as discussed, a pupil-to-pupil mode is possible wherein piano pupils instruct and encourage each other without the need to be co-located.

The device may enable improving the making of YouTube® music tutorial videos whereby the viewer can see more clearly which notes are being played. This can be achieved through an echo mode selected in the app where each key press on keyboard 11 causes its corresponding local light on the device 13 to be lit. This does not require the watcher of the video to be using the system of the invention. The notes played on keyboard 11 shown as lights lit on device 13 is clearer than watching the player's fingers alone.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A peripheral device for use in a method of teaching piano having a first piano keyboard and a second piano keyboard remote from the first, comprising:
an elongate body configured for, in use, arranging across keys of the first piano keyboard;
a plurality of visual indicators visible on the surface of the elongate body, alignable in use with keys of the first piano keyboard;
at least one communication port;
the device configured such that, in use, a key triggered at the second piano keyboard activates one of the plurality of visual indicators corresponding with the key triggered at the second piano.

2. The peripheral device of claim 1 wherein the communication port is at least one of:
a wireless connection to a mobile device;
a cable connection for transmitting MIDI information to and/or from the piano keyboard.

3. The peripheral device of claim 1, wherein a surface of the elongate body is profiled to fit/mate against a piano keyboard.

4. The peripheral device of claim 1, wherein at least part of the elongate body is of a flexible construction.

5. The peripheral device of claim 1, wherein the elongate body of the device is comprised of a plurality of modules, each of which represent an octave of a piano keyboard.

6. The peripheral device of claim 1, in the form of a novelty shape.

7. The peripheral device of claim 6, wherein the novelty shape is an animal, e.g., a snake.

8. The peripheral device of claim 1, wherein an indicator is capable of transmitting at least one colour, a colour being associated with a finger position, finger number, and/or particular finger of the hand.

9. A method for teaching piano, utilising a peripheral device according to claim 1, comprising:
arranging the plurality of visual indicators across the first piano keyboard, each indicator being associated with a key of the first piano keyboard;
triggering a key on the second piano keyboard, remote from the first piano keyboard, to activate one of the plurality of visual indicators;
wherein the triggered key on the second keyboard corresponds to a key of the first piano keyboard associated with the activated indicator.

10. The method of claim 9, wherein a triggered key of the first or second piano keyboard activates a sound at the second or first piano keyboard respectively.

11. A system for teaching piano, comprising:
a first piano keyboard;
a peripheral device according to claim 1;
a second piano keyboard, remote from the first piano keyboard, in communication with the peripheral device;
wherein a key triggering event on the second piano keyboard is communicated to the peripheral device to activate a visual indicator, the triggered key of the second piano keyboard corresponding with the key of the first piano keyboard associated with the activated indicator.

12. The system of claim 11, wherein communication between the second piano keyboard and the piano teaching device is over the internet.

13. The system of claim 11, wherein there is a second peripheral device according to claim 1 for, in use, arrangement across the second piano keyboard; wherein a key triggering event on the second piano keyboard is communicated to the first piano keyboard to be played by a sound generating means thereat.

14. The system of claim 13, wherein a key triggering event on the first piano keyboard is communicated to the second piano keyboard to be played by a sound generating means thereat.

15. The system of claim 11, wherein the peripheral device is in communication with a mobile device.

16. The system of claim 15, wherein the mobile device includes a processor and a display.

17. The system of claim 15, wherein the mobile device is in wireless communication with the peripheral device.

18. The system of claim 11, wherein the peripheral device is in communication with the first and/or second piano keyboard for bi-directional exchange of MIDI information.

19. The system of claim 11, further including memory storage means.

20. The system of claim 11, configured for encoding ultrasonic signals for triggering a visual indicator.
